(19) United States
(12) Patent Application Publication
(10) Pub. No.: US 2025/0200279 A1
(43) Pub. Date: Jun. 19, 2025

(54) GENERATIVE ARTIFICIAL INTELLGENCE TOOL FOR PATENT PROSECUTION

(71) Applicant: Black Hills IP Holdings, LLC, Minneapolis, MN (US)

(72) Inventor: Steven W. Lundberg, Edina, MN (US)

(21) Appl. No.: 18/988,326

(22) Filed: Dec. 19, 2024

Related U.S. Application Data
(60) Provisional application No. 63/612,222, filed on Dec. 19, 2023.

(51) Int. Cl. G06F 40/20; G06F 9/451

(52) U.S. Cl. CPC G06F 40/20; G06F 9/453

(57) ABSTRACT

Various embodiments disclosed relate to a method of producing an analysis document using generative artificial intelligence, the method comprising: maintaining a database containing multiple language learning models and a collection of prompts; generating a patent prosecution tool user interface integrated with a generative artificial intelligence program; receiving a user input comprising a matter associated with at least one matter dataset, where the matter dataset includes a plurality of patent documents associated with the matter; selecting a language learning model from the database; retrieving a plurality of patent documents for display on the patent prosecution tool user interface; loading at least one of the plurality of patent documents into the artificial intelligence program; displaying more than one prompt from the collection of prompts; initiating a script in the generative artificial intelligence program based on a user selected prompt and the at least one patent document; analyzing the patent document according to the script to produce a preliminary analysis; producing the analysis document according to the preliminary analysis; saving the analysis document.

### CLAIM OF PRIORITY

This application claims the benefit of priority under 35 U.S.C. § 119(e) to U.S. Patent Application Ser. No. 63/612,222, filed on Dec. 19, 2023, which is incorporated by reference herein in its entirety.

### BACKGROUND

Patent prosecution and preparation often require an attorney or agent to look through and analyze a large number of documents. For example, where an attorney or agent is preparing an office action response, they often review the office action, the published application, and any cited prior art, in addition to prosecution history. The attorney or agent may look through such documents while preparing a response strategy, and analyze the contentions of the office action or interpretation of the prior art prior to or during the course of writing a response document.

The process for drafting an office action response, for example, may involve referencing multiple documents while drafting. Historically, it may have been inefficient and time consuming to load all reference documents necessary for drafting the office action response. The process may involve downloading documents from databases, preparing response templates, referencing prior art, and drafting an argument for response.

Generative artificial intelligence (AI) has been increasingly prevalent in a variety of fields, including patent prosecution. Generative AI is capable of generating text, images, or other media, using generative models based on training data. Such generative AI tools have been leveraged for general text production, research, and analysis. Generative AI tools may also be useful for increasing efficiency in patent prosecution, however the present technology has drawbacks.

One drawback of present generative AI programs is an inability to retain a series of prompts and subsequent AI generated analysis for reference in the future. A user may forget what prompt was used to generate a specific piece of analysis and fail to recreate it in the future. A generative AI program may also lack the ability to organize and save a series of prompts and analysis documents.

Additionally, when present generative AI programs lack a corpus of reference documents, the programs have generated analysis documents with little to no support. Thus, there is a need for generative AI programs which have the ability to automatically load reference documents into their corpus and receive documents from a user prior to generating a response to a prompt.

Modern day patent prosecution therefore involves referencing several documents, templates, and, AI generated analysis simultaneously. This involves two components-file history/management and AI technology. There is a need for a system which seamlessly integrates the official record and associated documents of a patent matter with the capabilities of AI technology to address the inefficiencies of working with these components separately.

### SUMMARY OF THE DISCLOSURE

In some aspects, the techniques described herein relate to a method of producing an analysis document using generative artificial intelligence, the method comprising: maintaining a database containing multiple language learning models and a collection of prompts; generating a patent prosecution tool user interface integrated with a generative artificial intelligence program; receiving a user input comprising a matter associated with at least one matter dataset, where the matter dataset includes a plurality of patent documents associated with the matter; selecting a language learning model from the database; retrieving a plurality of patent documents for display on the patent prosecution tool user interface; loading at least one of the plurality of patent documents into the artificial intelligence program; displaying more than one prompt from the collection of prompts; initiating a script in the generative artificial intelligence program based on a user selected prompt and the at least one patent document; analyzing the patent document according to the script to produce a preliminary analysis; producing the analysis document according to the preliminary analysis; saving the analysis document.

In some aspects, the techniques described herein relate to a system comprising: a processor; and a memory having instructions thereon, when executed by the processor, cause the system to perform operations comprising: maintaining a database containing multiple language learning models and a collection of prompts; generating a patent prosecution tool user interface integrated with a generative artificial intelligence program; receiving a user input comprising a matter associated with at least one matter dataset, where the matter dataset includes a plurality of patent documents associated with the matter; selecting a language learning model from the database; retrieving a plurality of patent documents for display on the patent prosecution tool user interface; loading at least one of the plurality of patent documents into the artificial intelligence program; displaying more than one prompt from the collection of prompts; initiating a script in the generative artificial intelligence program based on a user selected prompt and the at least one patent document; analyzing the patent document according to the script to produce a preliminary analysis; producing the analysis document according to the preliminary analysis; saving the analysis document.

In some aspects, the techniques described herein relate to a non-transitory computer readable medium comprising: instructions when executed by a processor, causes the processor to perform operations comprising: maintaining a database containing multiple language learning models and a collection of prompts; generating a patent prosecution tool user interface integrated with a generative artificial intelligence program; receiving a user input comprising a matter associated with at least one matter dataset, where the matter dataset includes a plurality of patent documents associated with the matter; selecting a language learning model from the database; retrieving a plurality of patent documents for display on the patent prosecution tool user interface; loading at least one of the plurality of patent documents into the artificial intelligence program; displaying more than one prompt from the collection of prompts; initiating a script in the generative artificial intelligence program based on a user selected prompt and the at least one patent document; analyzing the patent document according to the script to produce a preliminary analysis; producing the analysis document according to the preliminary analysis; saving the analysis document.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is a block diagram of an automated docketing system in an example.

FIG. 2 is a block diagram of an example method for generating a file history tool user interface.

FIG. 3 illustrates a method of using a file history tool integrated with a patent prosecution tool and a generative artificial intelligence tool.

FIG. 4 illustrates a method of handling documents by using a patent prosecution tool integrated with a generative artificial intelligence tool.

FIG. 5 illustrates a method of using a generative artificial intelligence tool for patent prosecution in an example.

FIG. 6 illustrates a method of using a generative artificial intelligence tool for patent prosecution in an example.

FIGS. 7A-7H are schematic drawings of user interfaces for use by a patent prosecution tool.

FIG. 8 illustrates a computer diagram in an example.

### DETAILED DESCRIPTION

The present disclosure describes, among other things, a patent preparation and prosecution tool which comprises a file history/management tool integrated with a generative artificial intelligence tool. The patent prosecution tool can be leveraged to, when prompted, retrieve documents related to the desired patent preparation or prosecution task, analyze those documents, and produce preliminary analysis of those documents and the desired patent case to a user, such as on a user interface. The patent prosecution tool can also integrate AI tools and AI analysis with the file history tool to improve the efficiency of patent preparation and prosecution.

A patent practitioner accomplishes a large number of tasks during the course of patent preparation and prosecution. For example, a practitioner may prepare a patent application based on a provided invention disclosure, or a practitioner may prepare a response to an office action issued by a patent office. In the course of many of these tasks, patent practitioners review and analyze a large amount of documents and information.

Many patent practitioners have incorporated generative artificial intelligence (AI) programs into their workflow to supplement their practice. Generative AI may be particularly useful to patent practitioners by providing a quick analysis of documents and information. However, AI programs differ greatly in their ability to analyze information depending on the subject matter. Some AI programs may be better suited than others for analyzing highly technical subject matter, for example. Therefore, patent practitioners may need to utilize several AI programs depending on the subject matter of the work they are doing.

The patent prosecution tool can be used to streamline and augment patent prosecution and preparation analysis by integrating a file history tool with a generative AI tool that contains multiple language learning models (LLMs). The file history tool may provide in one central location all publicly available documents relating to a matter as well as documents saved from the AI tool, customized templates, and analysis documents. The file history tool may be populated with useful generative AI prompts to improve the process of patent preparation and prosecution.

As used herein, “application” or “program” can include a program or piece of software designed and written to fulfill a particular purpose of the user, such as a database application.

As used herein, “artificial intelligence” or “AI” refers to the use of computer systems to perform tasks such as visual perception, speech recognition, translation, decision-making, and other tasks based on training data.

As used herein, “associate” can include a partner or colleague in business or at work, either internal or external.

As used herein, “database,” can refer to a structured set of data, such as held in a computer or on the internet, that can be accessible in various ways.

As used herein, “file” or “matter” can refer to a particular project, enterprise, or undertaking being worked on by an individual or a collaborative group, planned and designed to achieve a particular aim.

As used herein, “generative artificial intelligence” refers to artificial intelligence that is capable of generating text, images, or other media, such as by learning patterns and structure of training data and then producing new data that is similar to the training data.

As used herein, “machine learning” refers to artificial intelligence used in a statistical algorithm to generalize and then perform tasks without specific instructions, but based on training.

As used herein, “official record,” or “file history,” can refer to data about a file or matter denoting evidence about past events or tasks within that file or matter, such as an electronic record of previous events in the file or matter. An “official record” can be stored with and maintained by an overseeing agency or organization, such as a governmental organization.

As used herein, “practitioner” or “patent practitioner” can refer to a patent attorney, patent agent, or other patent prosecution practicing personnel licensed in the relevant jurisdiction.

As used herein, “scraping”, “web scraping”, “data scraping”, or “web crawling”, can refer to automatically mining or collecting data or information, such as from a database or from the internet.

As used herein, “script” can refer to content generated by a language learning model integrated with a generative artificial intelligence tool.

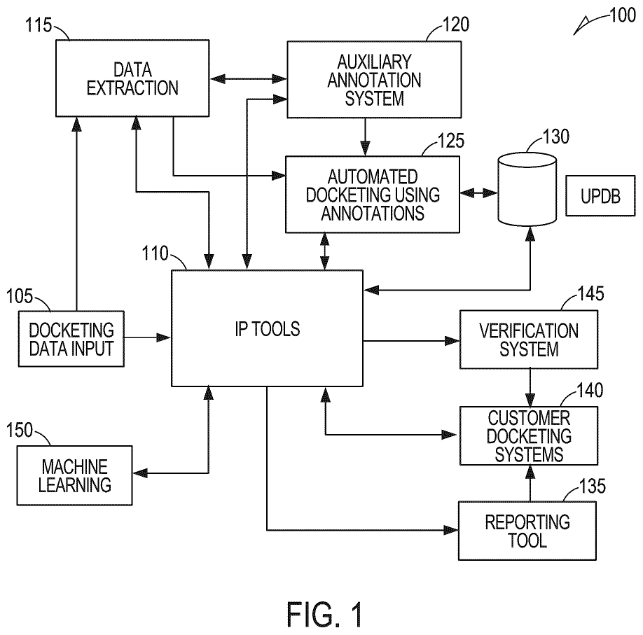

FIG. 1 is a block diagram of an automated docketing system 100 in an example.

The docketing system 100 may be automated or semi-automated. The docketing system 100 may include docketing data input 105, docketing manager system 110, data extraction system 115, Auxiliary Annotation System 120, automated docketing tool 125, Universal Procedures Database (UPDB) 130, reporting tool 135, customer docketing system 140, verification system 145, and machine learning model system 150.

The docketing system 100 may receive documents from third party sources including third party docketing systems and/or customer data as docketing data input 105. The docketing manager system 110 may process the received documents to provide to the customer docketing system 140 and prepare the documents for data extraction by the data extraction system 115 as needed.

The data extraction system 115 may perform Optical Character Recognition (OCR) on the received documents from the docketing manager system 110 to extract unstructured data, read checkboxes, extract lists, and identify documents where possible, including official records and file histories. The docketing manager system 110 may also integrate with the UPDB 130 to provide automated docketing by an automated docketing tool 125 that processes received documents based on the additional annotations added to the documents based on the complex data extraction performed by the Auxiliary Annotation System (AAS) 120.

The AAS 120 may further identify the received documents without using an OCR. To manage this process, the docketing manager system 110 may receive frequent updates of docketing procedure rules including configuration data and updates the UPDB 130 with universal procedure codes (UPCs) as appropriate. The UPCs may be used in conjunction with customer specific codes, checklists, and templates. The rules may specify how to fill in the templates and how to complete customer-specific procedures such as how to docket documents into the customer docketing system 140, for example. The template may be filled out by pulling in attributes from the annotations in a document.

The AAS 120 may be an integrated or separate system that works with the data extraction system 115 and the docketing manager system 110. The AAS 120 may be used to sort unstructured data, such as data in the docketing manager system 110, and apply annotations, tags, or labels to that data, such as prior to moving that data to automated docketing tool 125. The AAS 120 may be used to annotate data extracted by the data extraction system 115. Data that may be annotated includes the type of rejections (or lack thereof), the number of cited references, the length of cited references, the length of an office action, whether it is the first office action received, the presence of a Rule 105 Request for Information, or the presence of allowed subject matter, for example.

In some cases, machine learning techniques may be used to generate annotations. For example, a database of past documents that have been identified may be provided by the docketing manager system 110 and used as a data warehouse to train and improve machine learning models by creating a training set for the machine learning model. Over time, the machine learning model system 150 may learn which Patent and Trademark Office (PTO) IDs to use for which documents, which document in a bundle of documents may be used to characterize the bundle, and may provide predicted PTO IDs for the received documents containing unstructured text. The machine learning model system 150 may also establish rule engine prediction capabilities for received documents that test the classifications.

The docketing manager system 110 may receive or intake electronic communications, documents, and docketing data from several different sources of docketing data input 105, validate the docketing requirements against entries in a customer docketing system 140, and communicate those documents to the customer docketing system 140 via a unified interface. The docketing manager system 110 may also route documents and associated docketing data through the data extraction system 115 and the AAS 120 and organize the returned metadata and annotations. The docketing manager system 110 thus may provide a breakout between the metadata and the document text.

The docketing manager system 110 may also keep records, including official records and file histories, and communicate with third-party application programming interfaces (APIs) to push the docketing data and documents automatically where allowed. Otherwise, the docketing manager system 110 may present the documents to human docketers to docket. The docketing manager system 110 may also issue reports upon request.

The docketing manager system 110 may be integrated with an existing docketing system (e.g., FOUNDATIONIP®), semi-integrated (e.g., CPI, ANAQUA®, etc.), may provide a virtual host that does not talk at all to the existing docketing system (e.g., IP Manager, MEMOTECH™), or may provide outputs in spreadsheet form for use by a docketing administrator to update the customer docketing system 140.

If the docketing manager system 110 and the customer docketing system 140 are not integrated, the data output of docketing system 100 may be presented to a human docketer for manual entry. For example, the human docketer may implement macros that interface with the customer docketing system 140 to populate the received data into the customer docketing system 140.

On the other hand, if the docketing manager system 110 and the customer docketing system 140 are integrated or semi-integrated, the data output may be processed to determine if any data is missing to automate the docketing process. If anything is missing, the human docketer may add that information before the automated docketing process may proceed further or the data may be auto-populated and mapped to the template from the UPDB 130.

The docketing system 100 may also perform several post-docketing actions, such as sending docketing reports/details to a verification system 145 that use a set of rules to verify proper docketing in a host system. The verification system 145 may verify that the data is correctly added to the customer docketing system 140. For example, the verification system 145 may pull data from the AAS 120, the docketing manager system 110, and the customer docketing system 140 to compare what is present to what is expected to be present in the respective systems.

The docketing system 100 may also provide automated “report out” electronic notifications to customers by implementing a reporting tool 135 that specifies docketing actions based on UPDB template configurations. The reporting tool 135 may also provide completed docketing reports to customers either directly or via the customer docketing system 140.

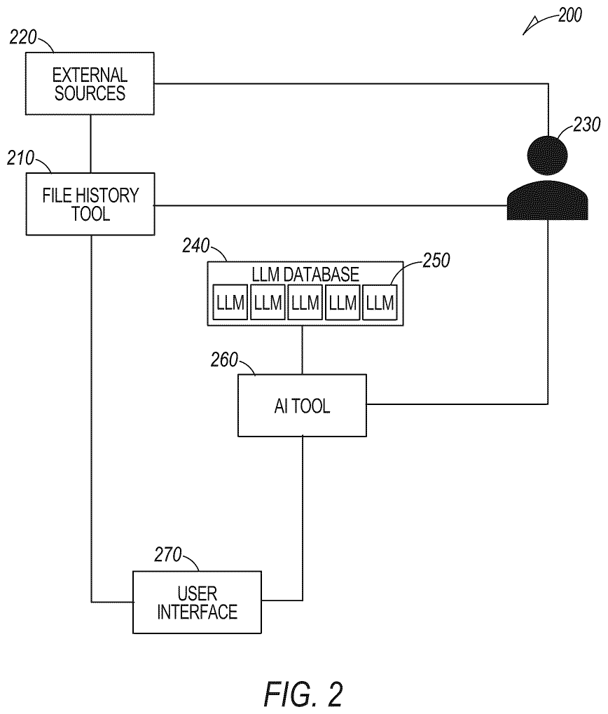

FIG. 2 is a block diagram of a patent prosecution system 200 including a file history tool integrated with a generative AI tool.

File history system 200 may include a file history tool 210, external sources 220, user 230, a language learning model (LLM) database including at least one LLM 250, AI tool 260, and user interface 270.

File history tool 210 may be integrated with docketing system 100 to provide annotated documents and templates relating to a patent matter.

File history tool 210 may upload one or more patent documents from external sources 220 to be stored within the tool. Uploading the one or more patent documents from external sources 220 may including scraping publicly available databases. The file history tool 210 may save AI generated analysis documents within the tool. A text editing program may be integrated with the file history tool 210, allowing a user 230 to make edits to patent documents or analysis documents within a user interface and save them to the file history tool 210 or an external source.

External sources 220 may include public databases containing patent documents such as the United States Patent and Trademark Office (USPTO). External sources 220 may also include docketing system 100.

A user 230 may provide a patent application number to the file history tool 210 identifying a matter to be worked on. A user 230 may download documents directly from external sources 220. A user 230 may also provide patent documents directly to the file history tool 210.

A user 230 may interact directly with AI tool 260 by providing a prompt, selecting a suggested prompt, uploading documents, and selecting an LLM 250.

LLM database 240 may store one or more LLMs for selection by a user 230. By providing one or more LLMs as an option for use with AI tool 260, the patent prosecution system 200 can be customized depending on the type of work to be completed. For example, a particular LLM 250 may be best suited for highly technical subject matter such that an AI tool 260 may provide more accurate analysis when the subject matter of the uploaded documents is highly technical in nature.AI tool 260 may load an LLM 250 from the LLM 240 database to be used in producing an analysis document in response to a prompt from user 230.

User interface 270 may include the file history tool 210 and AI tool 260. User interface 270 may include an AI chatbot chat window for generating analysis documents in response to receiving a prompt. The user interface 270 may display documents that have been uploaded to file history tool 210, as well as templates generated by docketing system 100, and analysis documents generated by the AI tool 260 and saved to the file history tool 210.

User interface 270 can be designed to seamlessly integrate the file history tool 210 and the AI tool 260. For example, a user 230 may select a document previously uploaded to the file history tool 210 for loading into the AI tool 260. A user 230 may then provide a prompt to the AI tool 260 requesting analysis of the document loaded into the AI tool 260. The AI tool 260 may subsequently produce an analysis document in response to the prompt. User interface 270 is designed such that a user 230 may then save the analysis document within the file history tool 210 for later use. User interface 270 may also provide a text editor program which the user 230 can use to load, edit, and export the analysis document.

### Patent Prosecution Tool Methods

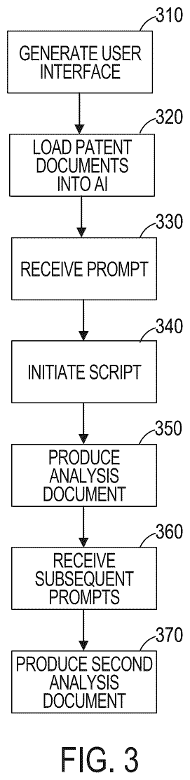

FIG. 3 illustrates a method of using a generative AI patent prosecution tool to produce an analysis document. Here, steps 310 to 370 can be done to leverage a file history tool with integrated generative artificial intelligence for aid in patent preparation and prosecution tasks.

At step 310 a patent prosecution tool user interface is generated.

To generate the patent prosecution tool user interface, a user may input an application number related to a pending patent application.

Once an application number has been provided, the file history tool may determine whether any related documents have been uploaded to the system related to the case. If documents have been uploaded, they may be listed on the user interface.

If documents have not been uploaded, or additional documents are desired, the file history tool may receive an indication from a user to automatically bulk upload all documents related to the case from an external source such as the USPTO public database. In an embodiment, any format of the documents may be uploaded to the user interface, such as PDF, .docx, JPG, PNG, XML, or zip files. In a further embodiment, the file history tool automatically bulk uploads all documents related to the case once the application number has been provided. A user also may upload a single document or multiple documents to the file history tool from their own external source (such as their computer). Having the related documents bulk uploaded to the file history tool may provide ease of use and speed for generating analysis with a generative AI tool.

Generating the user interface may also comprise determining a language learning model for use with an integrated generative artificial intelligence tool. The patent prosecution tool may store multiple language learning models for use with the generative artificial intelligence tool, such as ChatGPT™, Perplexity AI, Claude 3.5 Sonnet, or others.

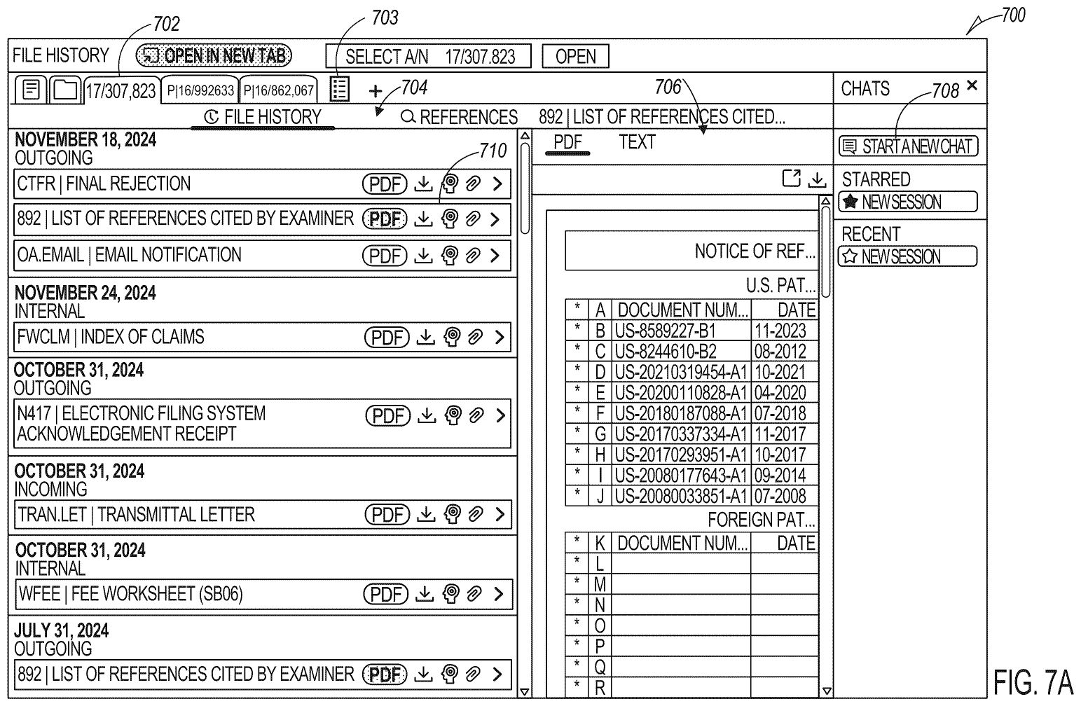

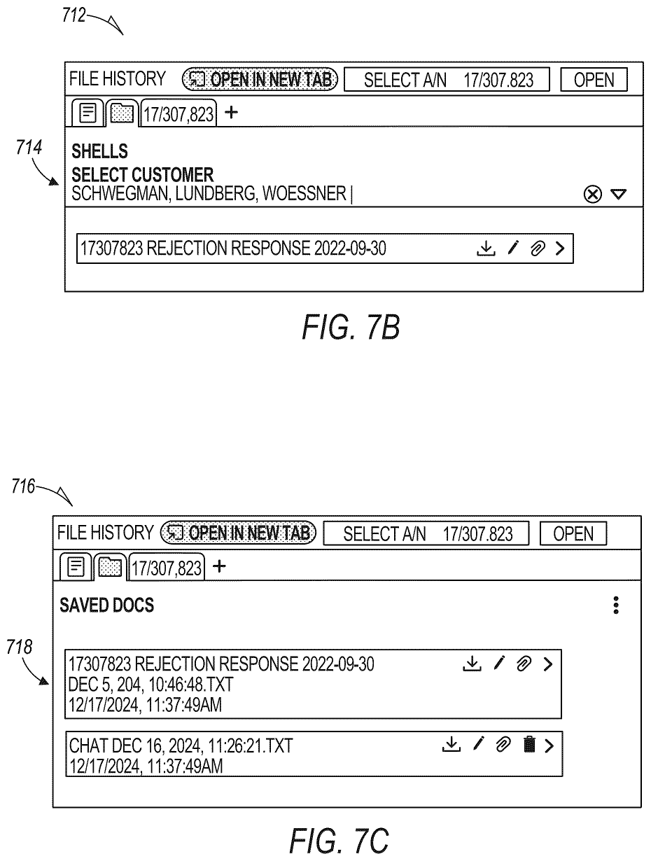

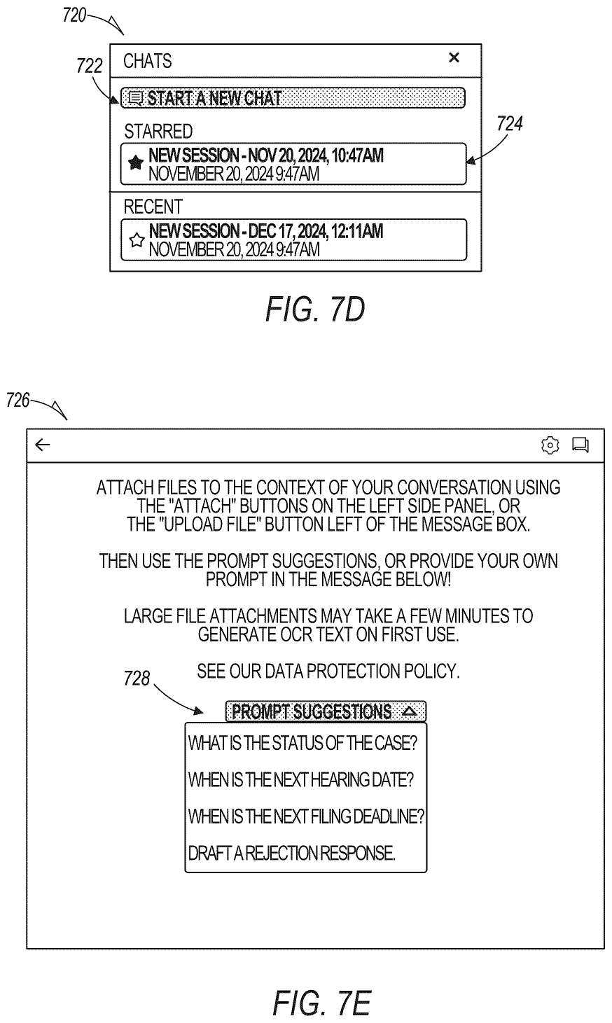

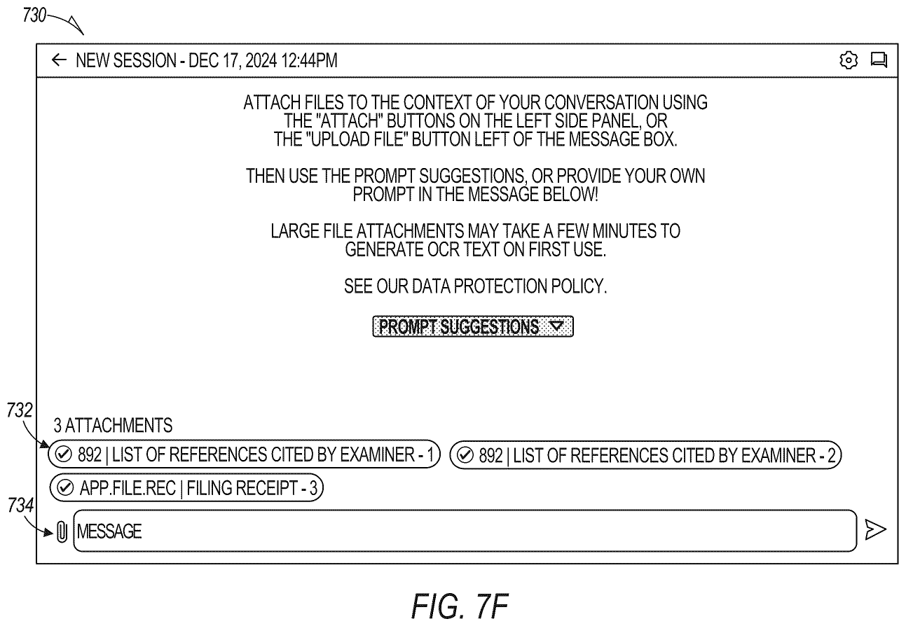

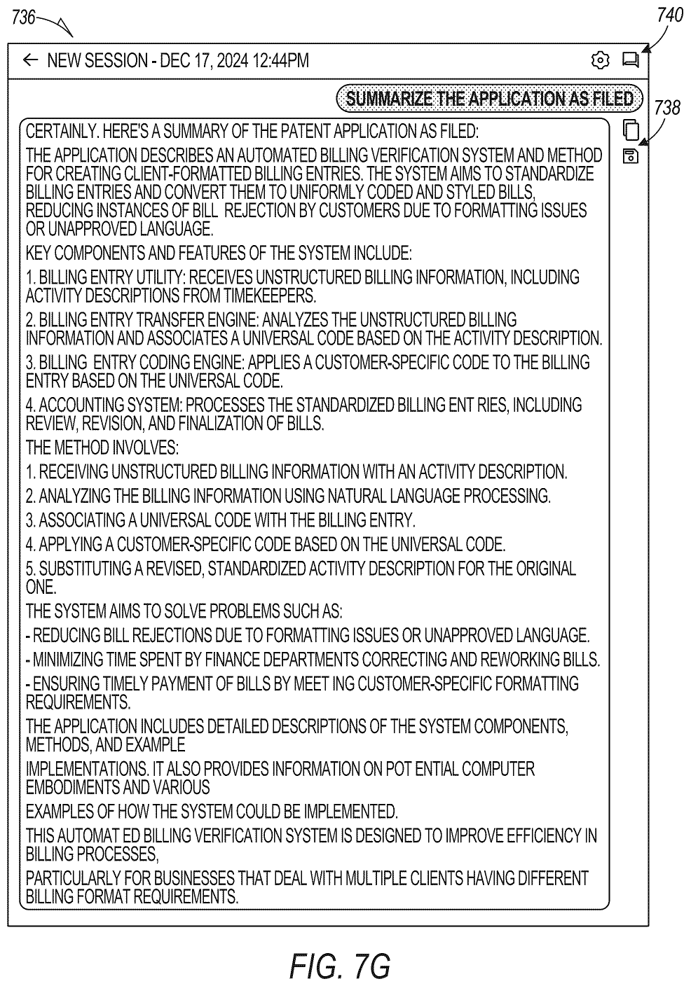

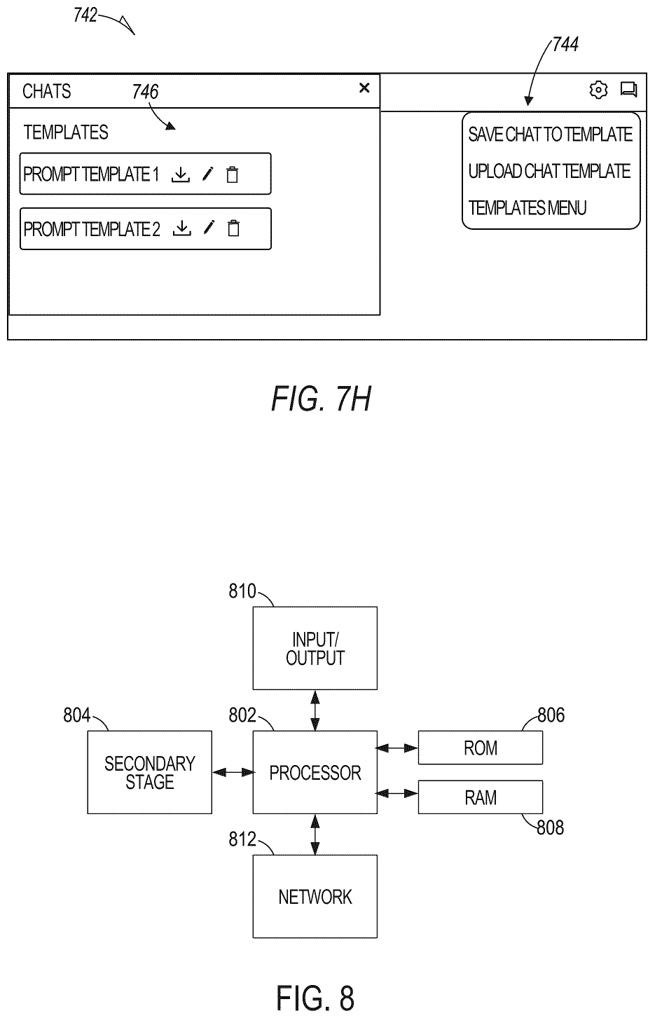

The user interface may be displayed according to FIGS. 7A-7H below.

At step 320 a user may select one or more patent documents from the uploaded documents to be loaded into a generative AI chatbot chat window. A user may upload patent documents directly into the generative AI tool from their computer by selecting an upload button within the chat window. A user may also select a button displayed on a document which has been previously uploaded into the file history tool for uploading directly into the generative AI tool.

Documents uploaded at step 320 can be related to the patent preparation and prosecution task. For example, such documents can include office actions, claim sets, disclosures, prior art, or other associated documents.

The generative AI tool may also use the provided application number to automatically retrieve related documents. For example, the generative AI tool can interface with one or more databases, such as a governmental run patent database, a third party operated patent database, or other intellectual property document database. In this case, the generative AI tool scrapes documents and associated data from the database.

The generative AI tool may reference the patent documents which have been loaded into the tool when generating a script in response to a prompt from a user.

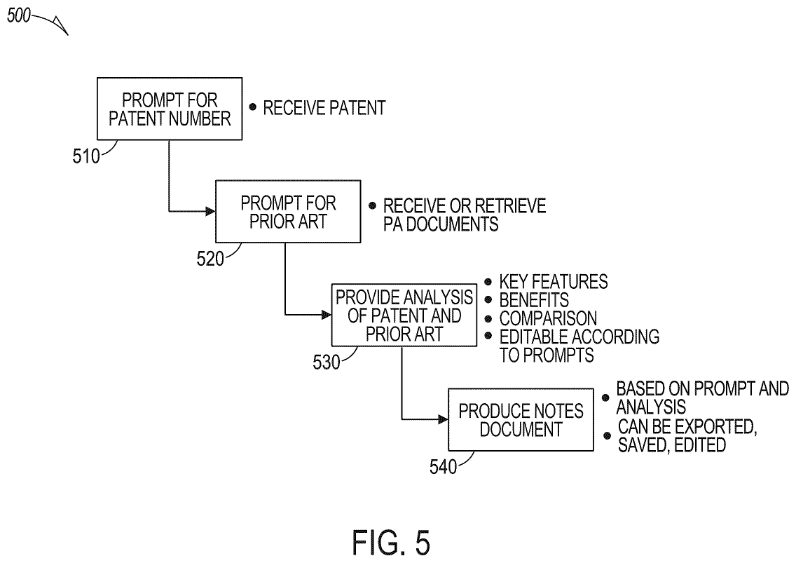

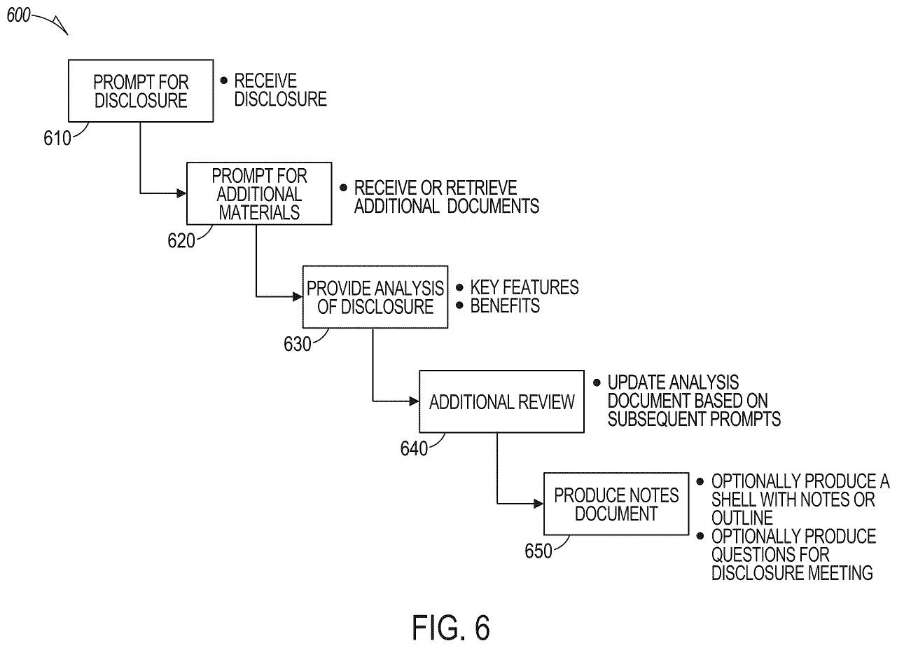

At step 330 a user may enter a prompt into the generative AI tool chat window, generating a request to run a script. Here, the user can indicate, such as on a user interface to the generative AI tool a desired task, such as an office action analysis, a disclosure analysis, or other patent prosecution or preparation task. Such a task may be associated with one or more scripts that the generative AI tool can initiate. Examples of specific types of tasks associated with predetermined scripts are shown and discussed with reference to FIGS. 5-6 below.

Alternatively, a user may select a suggested prompt from the generative AI tool. The suggested prompts may be generated based on common prompts for analyzing patent documents. Suggested prompts may include “What is the status of the case?”, “When is the next hearing date?”, “When is the next filing deadline?”, or “Draft a rejection response.”, for example. The example prompts may be displayed in a drop-down menu contained within the generative AI chat window.

Alternatively, the file history tool may display AI generated prompts with the previously uploaded patent documents. For example, a previously uploaded Office Action may be displayed with a suggested prompt such as “summarize the document”.

At step 340 the generative AI tool may initiate a script based on the received prompt and the uploaded documents. The generative AI tool can analyze the retrieved documents according to the script. For example, the generative AI tool can read the full text of the documents and extrapolate various pieces of analysis. For example, the generative AI tool can highlight themes, details about various embodiments, benefits or advantages of inventions, claim scopes, support for scopes, or other items or pieces of analysis. The generative AI tool can produce such information within the AI chat window for a user to read.

The generative AI tool may utilize a scripting language which includes a plurality of standardized terms and associated variable terms for use while initiating a script. For each standardized term, there may be multiple variable terms. A standardized term may be a term that is used by official entities such as the USPTO. A variable term may be a term that is used colloquially by others in the industry. For example, the standardized term “CTFR” might be associated with the variable terms “final rejection”, “final office action”, and “foa”.

Initiating a script based on the received prompts and the uploaded documents may involve recognizing that a user has input a variable term and replacing that variable term with the standardized term in order to streamline the script initiation process. Doing so may also improve user experience by increasing the likelihood of the AI tool generating accurate analysis documents when colloquial language is used in a prompt.

The standardized terms stored with a generative AI tool may correspond directly with the terms used by the file history tool and the USPTO. This may further streamline the integration between the file history tool and the generative AI tool by improving the accuracy of actions to be taken against a document uploaded to the file history tool, for example.

At step 350 the generative AI tool may produce an analysis document. The analysis document may include reference to patent documents which were uploaded to the generative AI tool. The analysis document may address the prompt provided by the user.

The contents of the analysis document may differ based on the language learning model selected by the user. The ideal language learning model may vary based on the task and the case being addressed.

At step 360, the generative AI tool can receive additional prompts from the user via the user interface. For example, the user may enter a prompt asking the generative AI tool to update the analysis document by comparing a specific piece of prior art to a pending application, such as discussed below with reference to FIGS. 5-6. The generative AI tool can provide a new analysis document containing answers and information in response to these additional queries.

At step 370, the generative AI tool can produce a document based on the analysis and query answers in response to the subsequent prompt. For example, the generative AI tool can automatically produce an outline for a response, a shell of a response, an overview of an invention, or other appropriate documents for use in patent prosecution and preparation.

Steps 360 and 370 may be repeated indefinitely as a user is working on a matter.

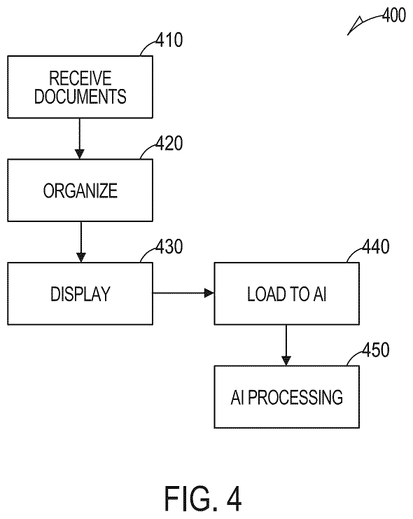

FIG. 4 is a block diagram depicting a method 400 of uploading documents into a file history tool for use with a generative AI tool.

At step 410 the file history tool may receive documents related to a matter identified by a user by providing an application number corresponding to the matter. Documents may be received directly from a user through a button on the user interface. Alternatively, the file history tool may automatically bulk upload all documents from a publicly available database such as the USPTO database by scraping the website and transferring all available documents relating to the matter to the file history tool. The file history tool may also receive analysis documents generated by the AI tool in response to a prompt from a user. Templates containing annotations may also be received by the file history tool from a docketing manager system, such as described above with reference to FIG. 1.

At step 420, the file history tool may organize the received documents. Organizing the received documents may involve naming the documents a standardized term such that the scripting language being used by the generative AI tool may accurately initiate scripts in response to a prompt from a user.

The file history tool may group documents received from the public database by event, and list each document chronologically. An event may be, for example, receiving an office action, paying an issue fee, receiving a restriction requirement, responding to an office action, or any correspondence to or from the USPTO relating to a particular matter.

Each identified event may have multiple documents associated with it. For example, when an office action is received, associated documents may include the office action itself, a list of references cited, and prior art documents referenced in the office action. In this example, the file history tool may recognize that an associated document is a prior art reference and store that prior art reference document with other prior art documents referenced during prosecution, while the office action itself may be stored with the list of references cited along with other events and associated documents relating to the matter.

The file history tool may also gather and organize analysis documents provided by the AI tool, templates generated by a docketing manager system, and prior art documents which have been referenced during prosecution. The file history tool may organize the templates generated by a docketing manager system based on customer. A customer may be, for example, a law firm or other entity tasked with managing a patent matter. The templates provided to the file history tool may vary based on customer, depending on customer preferences.

At step 430, the file history tool may display documents associated with the matter. References may be displayed together. Documents associated with an event may be grouped together and displayed chronologically. After receiving a selection of a customer, templates associated with that customer and the identified matter may be displayed. Documents generated by the AI tool which have been saved by a user may also be displayed. Each category of documents may be displayed separately to aid a user in efficiently locating them.

At step 440 document associated with a matter may be loaded into an AI tool. A user may load documents in the AI tool directly by selecting an upload button on the AI chatbot chat window. A user may also select an upload button displayed on a document itself to load that document into the AI tool.

In an embodiment, the AI tool may automatically load documents based on a prompt provided from a user. For example, the AI tool may receive a prompt stating “compare the prior art referenced in the most recent office action with the prior art referenced in the previous office action”. In response to this prompt, the AI tool may automatically load the office actions and the prior art references for use in generating a script in response to the prompt.

At step 450, the AI tool will process the prompt and loaded documents in order to generate an analysis document based on the request in the prompt.

FIG. 5 illustrates a method 500 of using a generative artificial intelligence tool for patent prosecution in an example. Here, the method 500 can include steps 510 to 540. In the method 500, a practitioner can leverage the generative artificial intelligence tool to analyze an office action received from a government patent office, such as the USPTO.

First, at step 510 the patent prosecution tool can produce a prompt on a user interface for a patent number. For example, the user interface of the patent prosecution tool can have a field for receiving a patent application number, a patent publication number, a docket number, or another bibliographic or identifying type number for a patent case. In this case, the file history tool can retrieve the described patent, such as from a governmental database, from a third-party database, or from an internal docketing system. The file history tool may also load any previously uploaded documents for a user to view on the user interface.

In some cases, the file history tool can receive a copy of the patent application or patent publication from a user, or a copy of the office action, search report, or other communication unique to the case, instead of identifying the case by a number or other identifying information. In this case, the generative AI tool can receive the patent document and, such as by using text recognition (e.g., optical character recognition [OCR], or other text recognition methods), identify the patent case itself.

Once the patent application in question has been identified, the generative AI tool can receive associated patent documents at step 520 to prepare for analysis. For example, the generative AI tool may prompt on the user interface for the user to attach related documents, such as the associated office action, official communications, prosecution history, cited prior art, prior responses, or related documents. In some cases, these documents can be manually inserted by the user and received by the generative AI tool. For example, where an office action analysis is in process, the generative AI tool can request copies of the cited prior art from the user.

In some cases, the file history tool can automatically scrape publicly available databases to retrieve desired documents. For example, where an office action analysis is in process, the generative AI tool can scrape the USPTO database and retrieve the office action document itself, the publication of the pending patent application, and/or cited prior art documents.

At step 530, the generative AI tool can provide analysis of the collected documents based on a prompt. For example, the prompt may be “provide an analysis of the office action and associated documents and recommend a response”. The generative AI tool can individually and/or collectively analyze the documents in response to the prompt. The generative AI tool can distill key features, benefits, themes, or other portions of the documents. In some cases, the generative AI tool can provide comparisons between various documents that have been uploaded. The analysis provided by the generative AI tool can be augmented and edited via additional prompts.

For example, depending on the prompt received, the generative AI tool can analyze the prior art cited in the office action. The AI tool can compare a prior art document with the pending patent application. The generative AI tool can provide differences between the prior art document and the pending patent application for a practitioner to review. In some cases, the generative AI tool can analyze the office action and provide suggested responses to the office action for the practitioner to review. For example, based on analysis of the office action arguments, the prior art, and the pending case, the generative AI tool can produce suggested strategies or approaches to the practitioner.

The generative AI tool can additionally produce text or images highlighting various portions of the documents that may be of interest to the practitioner.

At step 540, the generative AI tool can produce an analysis document containing the tool's response to the user-entered prompt. The analysis document may be displayed in the generative AI tool chat window for review. The analysis document may also be saved to a user's computer or saved to the file history tool. The file history tool may also display the analysis document within a text editing interface within the patent prosecution tool. The analysis document may be retained by the generative AI tool for future use if a subsequent prompt is received which requests the tool to reference the document.

FIG. 6 illustrates a method 600 of using a generative AI tool for patent prosecution in an example. Here, the generative AI tool can aid a practitioner in analyzing an invention disclosure, such as in preparation for drafting a patent application.

At step 610, the generative AI tool can, such as on a user interface, prompt a user for the receipt of an invention disclosure. The generative AI tool can receive the invention disclosure, such as by insertion through a button or field of the user interface. The disclosure can include a single document or multiple documents.

At step 620, the generative AI tool can prompt a user for any additional materials. In some cases, the generative AI tool can retrieve related documents, such as from a database.

Alternatively, a user may choose to upload selected documents into the generative AI chat window. The documents may be retrieved from the file history tool itself or from other external sources.

In an embodiment, the generative AI tool instead receives a prompt from a user after uploading additional materials. The prompt may be, for example, “provide an analysis of the disclosure and associated documents”.

In a further embodiment, a user may select a suggested prompt from a drop-down menu of AI generated prompts. The drop-down menu of AI generated prompts may be displayed within the generative AI chat window or adjacent to a previously uploaded document displayed in the patent prosecution tool user interface.

At step 630, the generative AI tool can provide analysis of the disclosure and related documents based on the received prompt. For example, the generative AI tool can provide a list of key features of the invention, an overview of the invention, or an analysis of the biggest benefits of the invention disclosure.

The AI provided analysis may be provided as an analysis document. The analysis document may be saved by a user to the file history tool or to an external source. The analysis document may be retained in the generative AI tool for referencing when subsequent prompts refer to the analysis document.

At step 640, the generative AI tool can provide additional review according to user inputted prompts. For example, the user can input various questions related to the uploaded documents and the analysis document.

At step 650, the generative AI tool can produce a final document, such as a notes document, summarizing the analysis provided. Optionally, the generative AI tool can provide a shell with notes or an outline for the practitioner. Optionally, the generative AI tool can produce a list of questions for the practitioner to ask the inventor.

The analysis document, shell, or outline may be uploaded into the user interface of the patent prosecution tool for editing through a text editor application. The analysis document may also be exported to external programs or sources for further use.

### Patent Prosecution Tool User Interface

FIGS. 7A-7H are schematic drawings of example user interfaces for use with the patent prosecution tool.

FIG. 7A is a schematic of an example user interface displaying a landing page 700.

At operation 702 the user interface displays a tab containing the application number of the matter being worked on as well as additional tabs containing the application numbers for each of the matter's parent patents. For example, if the matter being worked on is a fifth continuation, operation 702 may display tabs for each of the four parent patents as well as the matter being worked on for selection by a user. In this example, the file history tool may have already bulk uploaded all documents associated with each of the parent patents to be displayed in the user interface. The tool may also display previously templates and previously saved AI generated analysis documents each of the parent patents.

At operation 703 a user may select a button which may initiate a script in the AI tool based on a prompt asking to compare the pending claims of the matter being worked on with the allowed claims of all parent patents. The AI tool may generate an analysis document based on this prompt and display the document to a user within the patent prosecution tool user interface.

At operation 704 a user may select either file history or references for display. The file history selection will display all associated documents previously uploaded to the file history tool. The documents may be organized by event and listed chronologically. The references selection will display all prior art documents previously referenced during prosecution of the matter. In an embodiment, operation 704 may display additional selections for a user.

At operation 706, a document is displayed in the center of the user interface. A user may view either a PDF or text version of the document. In an embodiment, additional formats of the document may be available for selection.

A user may also have the option at operation 706 to share the document to an external source or save the document to the file history tool or the user's computer.

At operation 708 a user may interact with a generative AI chatbot through a chat window. A user may initiate a new chat session or select a previous chat session from a list displayed in the AI tool. Chat sessions may be starred by a user and displayed at the top of the list of chat sessions.

At operation 710 a user may select from various buttons displayed with each document listed in the file history. For example, the various buttons may include options to download the document, load the document into the AI tool, load the document in the text editing window, or may include suggested prompts for use with the AI tool. For example, a button displayed on a document may correspond with a prompt of “click to draft response”. The suggested prompts may be customized based on the type of document it is associated with. For example, a final rejection document may also include the suggest prompts of “click to summarize” or “click to update references”. In an embodiment, each document listed in the file history may include a drop-down menu of AI generated suggested prompts which are customized based on the document type.

Operation 710 may further include buttons indicating the formats which each document is available in. For example, if a document is available in PDF, .docx, and PNG formats, buttons corresponding to those formats will be available for the user to select and then view that format of the document in the patent prosecution tool user interface.

FIG. 7B is a schematic of an example user interface 712 displaying document shells or templates.

At operation 714 a user may select a customer. A customer may be a law firm or other entity tasked with managing a patent matter or patent portfolio. Once a customer is selected, the user interface 712 may display all templates or shells that have been generated for that customer and the matter being worked on.

FIG. 7C is a schematic of an example user interface 716 displaying saved documents.

Operation 718 includes a list of saved documents, unique to the user. For example, the list of saved documents may include a rejection response template and an analysis document generated by the AI tool and saved to the file history tool.

User interface 716 displaying saved documents may be utilized for advanced integration between the file history tool and the AI tool. For example, when prompt templates are run (according to the process described in reference to FIG. 7H), the patent prosecution tool may automatically output the chat session and associated analysis document(s) to the saved documents user interface section of the file history tool. Similarly, when a user selects a button according to operation 703 and the AI tool receives a prompt comparing pending claims with allowed claims in the patent family, the patent prosecution tool may automatically save the analysis from the AI tool within the saved documents user interface.

FIG. 7D is a schematic of an example user interface 720 displaying a generative AI tool.

At operation 722 a user may start a new chat with a generative AI chatbot. The new chat may not include any documents loaded into the AI tool. Alternatively, a new chat may include all documents uploaded into the AI tool as part of a bulk upload of documents from the USPTO database, other publicly available databases, or from a user directly.

At operation 724 a user may select any previous chatbot sessions. The previous chatbot sessions are listed in user interface 720 and may include chatbot sessions which have been previously starred by a user as well as other chatbot sessions which have not been previously starred by a user.

FIG. 7E is a schematic of an example user interface 726 displaying a generative AI chatbot chat window.

At operation 728 a user may select a suggested prompt from a drop down menu of prompts generated by the AI tool. The AI tool may generate several suggested prompts which may generally be useful for analyzing a patent matter. The AI tool may also generate several curated prompts which may relate to documents previously uploaded to the AI tool. Alternatively, a user may choose to submit a user-drafted prompt rather than selecting a suggested prompt.

FIG. 7F is a schematic of an example user interface 730 displaying a generative AI tool containing uploaded documents.

At operation 732 documents which have been loaded into the AI tool may be displayed. The AI tool may display multiple documents which have been loaded into the tool.

At operation 734 a user may select a button to upload additional documents directly into the AI tool.

FIG. 7G is a schematic of an example user interface 736 displaying a chat session within the generative AI chatbot chat window.

The chat session contains a prompt and an analysis document in response to the prompt.

At operation 738 a user may select various buttons displayed in relation to the analysis document. The various buttons may include, for example, an option to copy the analysis document and an option to save the analysis document to the file history tool. The analysis document may be retained by the AI tool for reference if a subsequent prompt is received from the user.

At operation 740, a user may select a prompt template menu.

FIG. 7H is a schematic of an example user interface 742 displaying a prompt template menu within the generative AI chatbot chat window.

At operation 744 the user interface may display a prompt template drop-down menu. The prompt template drop-down menu may include options such as “Save Chat to Template”, “Upload Chat Template”, and “Templates Menu”. A prompt template may include multiple prompts which were received by the generative AI tool in a single chat session.

At operation 746 the user interface may display a templates menu containing prompt templates which have been saved by a user. From this menu, a user may save the prompt template, edit the prompt template, delete the prompt template, or other actions.

When a user selects a prompt template from the templates menu, the corresponding chat session may be loaded within the AI tool and the prompts contained in the chat session may be run again by the AI tool. The AI tool may provide a user with an option to run the prompts on auto mode or manual mode. Running the prompts on manual mode may require a user to select a single prompt from a drop-down menu to be run in the chat session. Running the prompts on auto mode may result in all of the prompts from the template being run again.

After a user runs a prompt template on either auto mode or manual mode, the patent prosecution tool may automatically save the chat session as a saved document for future use and reference within the saved documents section referenced in FIG. 7C.

Running a prompt template in the AI tool may involve initiating a script using the scripting language which has stored standardized terms and variable terms.

### Computer Embodiment

FIG. 8 is a block diagram of a typical, general-purpose computer 500 that may be programmed into a special purpose computer suitable for implementing one or more embodiments of the manifest record generating program disclosed herein. The manifest record generating program described above may be implemented on any general-purpose processing component, such as a computer with sufficient processing power, memory resources, and communications throughput capability to handle the necessary workload placed upon it. The computer 800 includes a processor 802 (which may be referred to as a central processor unit or CPU) that is in communication with memory devices including secondary storage 804, read only memory (ROM) 806, random access memory (RAM) 808, input/output (I/O) devices 810, and network connectivity devices 812. The processor 802 may be implemented as one or more CPU chips or may be part of one or more application specific integrated circuits (ASICs).

The secondary storage 804 is typically comprised of one or more disk drives or tape drives and is used for non-volatile storage of data and as an over-flow data storage device if RAM 808 is not large enough to hold all working data. Secondary storage 804 may be used to store programs that are loaded into RAM 808 when such programs are selected for execution. The ROM 806 is used to store instructions and perhaps data that are read during program execution. ROM 806 is a non-volatile memory device that typically has a small memory capacity relative to the larger memory capacity of secondary storage 804. The RAM 808 is used to store volatile data and perhaps to store instructions. Access to both ROM 806 and RAM 808 is typically faster than to secondary storage 804.

The devices described herein may be configured to include computer-readable non-transitory media storing computer readable instructions and one or more processors coupled to the memory, and when executing the computer readable instructions configure the computer 800 to perform method steps and operations described above with reference to FIG. 3 to FIG. 6. The computer-readable non-transitory media includes all types of computer readable media, including magnetic storage media, optical storage media, flash media and solid-state storage media.

It should be further understood that software including one or more computer-executable instructions that facilitate processing and operations as described above with reference to any one or all of steps of the disclosure may be installed in and sold with one or more servers and/or one or more routers and/or one or more devices within consumer and/or producer domains consistent with the disclosure. Alternatively, the software may be obtained and loaded into one or more servers and/or one or more routers and/or one or more devices within consumer and/or producer domains consistent with the disclosure, including obtaining the software through physical medium or distribution system, including, for example, from a server owned by the software creator or from a server not owned but used by the software creator. The software may be stored on a server for distribution over the Internet, for example.

Also, it will be understood by one skilled in the art that this disclosure is not limited in its application to the details of construction and the arrangement of components set forth in the description or illustrated in the drawings. The embodiments herein are capable of other embodiments, and capable of being practiced or carried out in various ways. Also, it will be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings. Further, terms such as up, down, bottom, and top are relative, and are employed to aid illustration, but are not limiting.

The components of the illustrative devices, systems and methods employed in accordance with the illustrated embodiments may be implemented, at least in part, in digital electronic circuitry, analog electronic circuitry, or in computer hardware, firmware, software, or in combinations of them. These components may be implemented, for example, as a computing program product such as a computing program, program code or computer instructions tangibly embodied in an information carrier, or in a machine-readable storage device, for execution by, or to control the operation of, data processing apparatus such as a programmable processor, a computer, or multiple computers.

A computing program may be written in any form of programming language, including compiled or interpreted languages, and it may be deployed in any form, including as a stand-alone program or as a module, component, subroutine, or other unit suitable for use in a computing environment. A computing program may be deployed to be executed on one computer or on multiple computers at one site or distributed across multiple sites and interconnected by a communication network. Also, functional programs, codes, and code segments for accomplishing the techniques described herein may be easily construed as within the scope of the present disclosure by programmers skilled in the art. Method steps associated with the illustrative embodiments may be performed by one or more programmable processors executing a computing program, code or instructions to perform functions (e.g., by operating on input data and/or generating an output). Method steps may also be performed by, and apparatus may be implemented as, special purpose logic circuitry, e.g., an FPGA (field programmable gate array) or an ASIC (application-specific integrated circuit), for example.

The various illustrative logical blocks, modules, and circuits described in connection with the embodiments disclosed herein may be implemented or performed with a general-purpose processor, a digital signal processor (DSP), an ASIC, a FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

Processors suitable for the execution of a computing program include, by way of example, both general and special purpose microprocessors, and any one or more processors of any kind of digital computer. Generally, a processor will receive instructions and data from a read-only memory or a random-access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computing program instructions and data include all forms of non-volatile memory, including by way of example, semiconductor memory devices, e.g., electrically programmable read-only memory or ROM (EPROM), electrically erasable programmable ROM (EEPROM), flash memory devices, and data storage disks (e.g., magnetic disks, internal hard disks, or removable disks, magneto-optical disks, and CD-ROM and DVD-ROM disks). The processor and the memory may be supplemented by or incorporated in special purpose logic circuitry.

Those of skill in the art understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill in the art further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the disclosure. A software module may reside in random access memory (RAM), flash memory, ROM, EPROM, EEPROM, registers, hard disk, a removable disk, a CD-ROM, or any other form of storage medium known in the art. An exemplary storage medium is coupled to the processor such the processor may read information from, and write information to, the storage medium. In the alternative, the storage medium may be integral to the processor. In other words, the processor and the storage medium may reside in an integrated circuit or be implemented as discrete components.

As used herein, “machine-readable medium” means a device able to store instructions and data temporarily or permanently and may include, but is not limited to, random-access memory (RAM), read-only memory (ROM), buffer memory, flash memory, optical media, magnetic media, cache memory, other types of storage (e.g., Erasable Programmable Read-Only Memory (EEPROM)), and/or any suitable combination thereof. The term “machine-readable medium” should be taken to include a single medium or multiple media (e.g., a centralized or distributed database, or associated caches and servers) able to store processor instructions. The term “machine-readable medium” shall also be taken to include any medium, or combination of multiple media, that is capable of storing instructions for execution by one or more processors, such that the instructions, when executed by one or more processors cause the one or more processors to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” as used herein excludes signals per se.

### Various Notes & Examples

In some aspects, the techniques described herein relate to a method of producing an analysis document using generative artificial intelligence, the method comprising: maintaining a database containing multiple language learning models and a collection of prompts; generating a patent prosecution tool user interface integrated with a generative artificial intelligence program; receiving a user input comprising a matter associated with at least one matter dataset, where the matter dataset includes a plurality of patent documents associated with the matter; selecting a language learning model from the database; retrieving a plurality of patent documents for display on the patent prosecution tool user interface; loading at least one of the plurality of patent documents into the artificial intelligence program; displaying more than one prompt from the collection of prompts; initiating a script in the generative artificial intelligence program based on a user selected prompt and the at least one patent document; analyzing the patent document according to the script to produce a preliminary analysis; producing the analysis document according to the preliminary analysis; saving the analysis document.

In some aspects, the techniques described herein relate to a method, wherein the plurality of patent documents associated with the matter are obtained by scraping one or more publicly available databases.

In some aspects, the techniques described herein relate to a method, further comprising receiving a second prompt from a user regarding the patent document and updating the preliminary analysis according to the second prompt prior to producing the analysis document.

In some aspects, the techniques described herein relate to a method, further comprising displaying the analysis document within the patent prosecution tool user interface for editing.

In some aspects, the techniques described herein relate to a method, wherein retrieving the plurality of patent documents comprises receiving the patent documents from a user.

In some aspects, the techniques described herein relate to a method, wherein retrieving the plurality of documents comprises scraping an external database.

In some aspects, the techniques described herein relate to a method, wherein the patent document comprises an invention disclosure, a patent publication, an issued patent, a prior art document, a communication from a government agency, or combinations thereof.

In some aspects, the techniques described herein relate to a system comprising: a processor; and a memory having instructions thereon, when executed by the processor, cause the system to perform operations comprising: maintaining a database containing multiple language learning models and a collection of prompts; generating a patent prosecution tool user interface integrated with a generative artificial intelligence program; receiving a user input comprising a matter associated with at least one matter dataset, where the matter dataset includes a plurality of patent documents associated with the matter; selecting a language learning model from the database; retrieving a plurality of patent documents for display on the patent prosecution tool user interface; loading at least one of the plurality of patent documents into the artificial intelligence program; displaying more than one prompt from the collection of prompts; initiating a script in the generative artificial intelligence program based on a user selected prompt and the at least one patent document; analyzing the patent document according to the script to produce a preliminary analysis; producing the analysis document according to the preliminary analysis; saving the analysis document.

In some aspects, the techniques described herein relate to a system, wherein the plurality of patent documents associated with the matter are obtained by scraping one or more publicly available databases.

In some aspects, the techniques described herein relate to a system, further comprising receiving a second prompt from a user regarding the patent document and updating the preliminary analysis according to the second prompt prior to producing the analysis document.

In some aspects, the techniques described herein relate to a system, further comprising displaying the analysis document within the patent prosecution tool user interface for editing.

In some aspects, the techniques described herein relate to a system, wherein retrieving the plurality of patent documents comprises receiving the patent documents from a user.

In some aspects, the techniques described herein relate to a system, wherein retrieving the plurality of documents comprises scraping an external database.

In some aspects, the techniques described herein relate to a system, wherein the patent document comprises an invention disclosure, a patent publication, an issued patent, a prior art document, a communication from a government agency, or combinations thereof.

In some aspects, the techniques described herein relate to a non-transitory computer readable medium, comprising: instructions when executed by a processor, causes the processor to perform operations comprising: maintaining a database containing multiple language learning models and a collection of prompts; generating a patent prosecution tool user interface integrated with a generative artificial intelligence program; receiving a user input comprising a matter associated with at least one matter dataset, where the matter dataset includes a plurality of patent documents associated with the matter; selecting a language learning model from the database; retrieving a plurality of patent documents for display on the patent prosecution tool user interface; loading at least one of the plurality of patent documents into the artificial intelligence program; displaying more than one prompt from the collection of prompts; initiating a script in the generative artificial intelligence program based on a user selected prompt and the at least one patent document; analyzing the patent document according to the script to produce a preliminary analysis; producing the analysis document according to the preliminary analysis; saving the analysis document.

In some aspects, the techniques described herein relate to a computer readable medium, wherein the plurality of patent documents associated with the matter are obtained by scraping one or more publicly available databases.

In some aspects, the techniques described herein relate to a computer readable medium, further comprising receiving a second prompt from a user regarding the patent document and updating the preliminary analysis according to the second prompt prior to producing the analysis document.

In some aspects, the techniques described herein relate to a computer readable medium, further comprising displaying the analysis document within the patent prosecution tool user interface for editing.

In some aspects, the techniques described herein relate to a computer readable medium, wherein retrieving the plurality of patent documents comprises receiving the patent documents from a user.

In some aspects, the techniques described herein relate to a computer readable medium, wherein retrieving the plurality of documents comprises scraping an external database.

Each of these non-limiting examples can stand on its own, or can be combined in various permutations or combinations with one or more of the other examples.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

What is claimed is:

1. A method of producing an analysis document using generative artificial intelligence, the method comprising:
maintaining a database containing multiple language learning models and a collection of prompts;
generating a patent prosecution tool user interface integrated with a generative artificial intelligence program;
receiving a user input comprising a matter associated with at least one matter dataset, where the matter dataset includes a plurality of patent documents associated with the matter;
selecting a language learning model from the database;
retrieving a plurality of patent documents for display on the patent prosecution tool user interface;
loading at least one of the plurality of patent documents into the artificial intelligence program;
displaying more than one prompt from the collection of prompts;
initiating a script in the generative artificial intelligence program based on a user selected prompt and the at least one patent document;
analyzing the patent document according to the script to produce a preliminary analysis;
producing the analysis document according to the preliminary analysis;
saving the analysis document.

2. The method of claim 1, wherein the plurality of patent documents associated with the matter are obtained by scraping one or more publicly available databases.

3. The method of claim 1, further comprising receiving a second prompt from a user regarding the patent document and updating the preliminary analysis according to the second prompt prior to producing the analysis document.

4. The method of claim 1, further comprising displaying the analysis document within the patent prosecution tool user interface for editing.

5. The method of claim 1, wherein retrieving the plurality of patent documents comprises receiving the patent documents from a user.

6. The method of claim 1, wherein retrieving the plurality of documents comprises scraping an external database.

7. The method of claim 1, wherein the patent document comprises an invention disclosure, a patent publication, an issued patent, a prior art document, a communication from a government agency, or combinations thereof.

8. A system comprising:
a processor; and
a memory having instructions thereon, when executed by the processor, cause the system to perform operations comprising:
maintaining a database containing multiple language learning models and a collection of prompts;
generating a patent prosecution tool user interface integrated with a generative artificial intelligence program;
receiving a user input comprising a matter associated with at least one matter dataset, where the matter dataset includes a plurality of patent documents associated with the matter;
selecting a language learning model from the database;
retrieving a plurality of patent documents for display on the patent prosecution tool user interface;
loading at least one of the plurality of patent documents into the artificial intelligence program;
displaying more than one prompt from the collection of prompts;
initiating a script in the generative artificial intelligence program based on a user selected prompt and the at least one patent document;
analyzing the patent document according to the script to produce a preliminary analysis;
producing the analysis document according to the preliminary analysis;
saving the analysis document.

9. The system of claim 8, wherein the plurality of patent documents associated with the matter are obtained by scraping one or more publicly available databases.

10. The system of claim 8, further comprising receiving a second prompt from a user regarding the patent document and updating the preliminary analysis according to the second prompt prior to producing the analysis document.

11. The system of claim 8, further comprising displaying the analysis document within the patent prosecution tool user interface for editing.

12. The system of claim 8, wherein retrieving the plurality of patent documents comprises receiving the patent documents from a user.

13. The system of claim 8, wherein retrieving the plurality of documents comprises scraping an external database.

14. The system of claim 8, wherein the patent document comprises an invention disclosure, a patent publication, an issued patent, a prior art document, a communication from a government agency, or combinations thereof.

15. A non-transitory computer-readable medium having stored thereon, instructions when executed by a processor, causes the processor to perform operations comprising:
maintaining a database containing multiple language learning models and a collection of prompts;
generating a patent prosecution tool user interface integrated with a generative artificial intelligence program;
receiving a user input comprising a matter associated with at least one matter dataset, where the matter dataset includes a plurality of patent documents associated with the matter;
selecting a language learning model from the database;
retrieving a plurality of patent documents for display on the patent prosecution tool user interface;
loading at least one of the plurality of patent documents into the artificial intelligence program;
displaying more than one prompt from the collection of prompts;
initiating a script in the generative artificial intelligence program based on a user selected prompt and the at least one patent document;
analyzing the patent document according to the script to produce a preliminary analysis;
producing the analysis document according to the preliminary analysis;
saving the analysis document.

16. The computer-readable medium of claim 15, wherein the plurality of patent documents associated with the matter are obtained by scraping one or more publicly available databases.

17. The computer-readable medium of claim 15, further comprising receiving a second prompt from a user regarding the patent document and updating the preliminary analysis according to the second prompt prior to producing the analysis document.

18. The computer-readable medium of claim 15, further comprising displaying the analysis document within the patent prosecution tool user interface for editing.

19. The computer-readable medium of claim 15, wherein retrieving the plurality of patent documents comprises receiving the patent documents from a user.

20. The computer-readable medium of claim 15, wherein retrieving the plurality of documents comprises scraping an external database.
